(19) United States
(12) Patent Application Publication
(10) Pub. No.: US 2009/0323672 A1
(43) Pub. Date: Dec. 31, 2009

(54) Techniques to enable emergency services in an unauthenticated state on wireless networks

(76) Inventors: Vivek Gupta, Milpitas, CA (US); Necati Canpolat, Beaverton, OR (US)

Correspondence Address: INTEL CORPORATION;c/o CPA Global, P.O. BOX 52050, MINNEAPOLIS, MN, 55402, US

(21) Appl. No.: 12/215,323

(22) Filed: Jun. 25, 2008

(51) Int. Cl. H04L 12/66; H04M 11/04

(52) U.S. Cl. 370/352; 455/404.1; 455/405; 455/404.2

(57) ABSTRACT

An embodiment of the present invention provides a method of enabling emergency services in an unauthenticated state on wireless networks, comprising attempting Extensible Authentication Protocol (EAP) authentication with a public user account by a client whose identity indicates the need to place an emergency call, authenticating the client by a Subscription Service Provider Network's (SSPN's) authentication, authorization and accounting (AAA) server and providing keying material to an authenticator and supplicant, thereby securing wireless link, providing by the SSPN's AAA server a virtual local area network identification (VLAN ID) back to an access point (AP), performing by the AP or a distribution system (DS) infrastructure a per-user policing for the VLAN ID ensuring upper-limit on resource usage commensurate with an emergency call, and routing the emergency call to a Public Safety Answering Point (PSAP) by the SSPN's call manager.

### BACKGROUND

There is a need to support Emergency Services (ES) such as e911 calling in wireless networks. This is especially true for mobile devices with voice/phone capabilities such as handhelds, ultra-mobile personal computers (UMPCs) and even notebooks. Supporting emergency services such as e911 calling requires a multi-layer solution with support at various layers. Apart from MAC level access and support for transfer of data between a wireless station (STA) and an access point (AP) with appropriate quality of service (QoS), there is a need to setup the emergency calls, conduct call control and management, and use appropriate standardized audio codecs.

In summary, there is a strong need for a system architecture for supporting emergency calls in a wireless environment, when a user is not Authenticated with the network, thereby allowing users to make emergency calls with any wireless network (public/private/enterprise) without having any specific relationship with the network provider.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a reference network for supporting Emergency Services in an embodiment of the present invention; and

FIG. 2 shows a flow diagram for placing an Emergency Call in an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Embodiments of the invention may be used in a variety of applications. Some embodiments of the invention may be used in conjunction with various devices and systems, for example, a transmitter, a receiver, a transceiver, a transmitter-receiver, a wireless communication station, a wireless communication device, a wireless Access Point (AP), a modem, a wireless modem, a Personal Computer (PC), a desktop computer, a mobile computer, a laptop computer, a notebook computer, a tablet computer, a server computer, a handheld computer, a handheld device, a Personal Digital Assistant (PDA) device or a handheld PDA device.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Currently wireless systems (for example, but not limited to, WiFi and WiMAX) don't really have support for emergency services when the user is UNAUTHENTICATED with the network. This limits deployment of handheld and mobile portable devices that support voice calls since the FCC is soon to mandate that wireless systems support emergency calls. Embodiments of the present invention provide a standardized architecture for supporting emergency services in different wireless environments. Further, it may be scalable across various wireless technologies.

Other key advantages include:

Network manages bandwidth consumption Over The Air (OTA) and thus minimizes susceptibility to DoS attack

Allows clients to discover Access Networks that support emergency services in a standard way.

Allows clients without credentials to place emergency calls in unauthenticated state.

Location information can be provided based on existing known mechanisms.

Call manager can validate that call has been routed to the correct PSAP.

Works with different signaling mechanisms like SIP, H.323 etc. and with various client side codecs such as G.711, AMR, Skype etc.

The access networks such as, but not limited to, 802.11 may not be able ensure that all emergency call capabilities are met in an end-to-end manner. It is rather a system level issue and the higher level call or connection manager in the client devices should be able to identify that the call is an emergency call, and verify that it will have the necessary end-to-end system support from the network for the emergency call; such as the ability to access the networks with emergency services (ES) capability and availability of other ES resources before it places the emergency call.

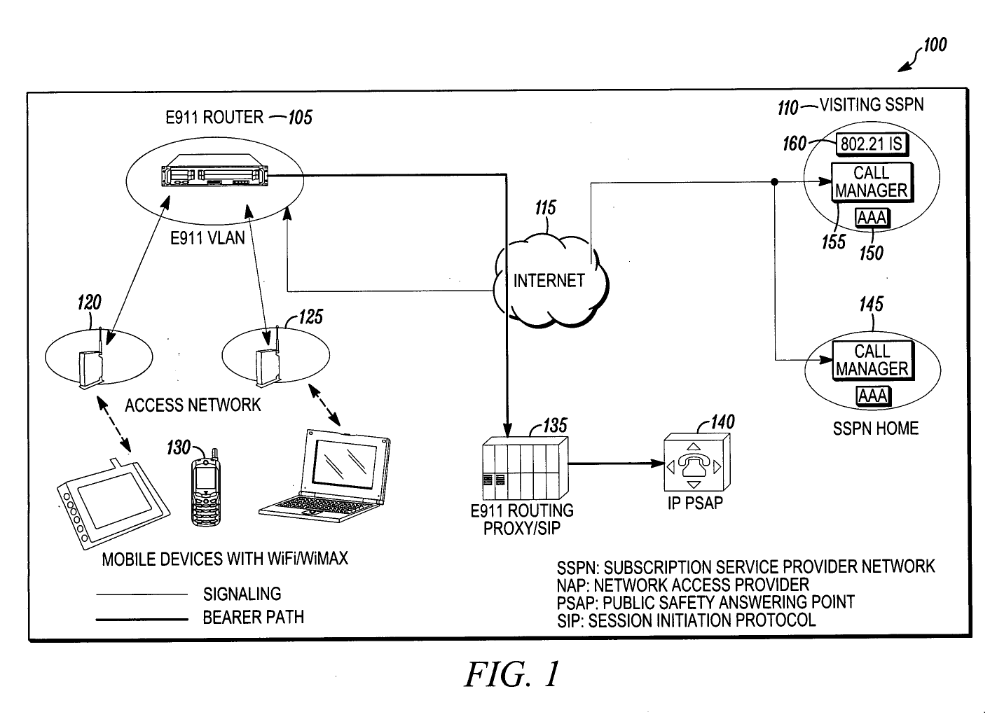

Looking at FIG. 1, generally shown as 100, is shown an example of a reference network with support for emergency services. The figure shows different reference configurations and the key elements involved in the architecture. The WLAN APs/WiMax BSs 120 and 125 establish an e911 VLAN (Virtual LAN) path with the e911 router 105. Mobile devices in communication with the access networks 120 and 125 are shown at 130. The WLAN AP marks all e911 traffic with e911 VLAN. The Emergency Services Routing proxy 135 or the SIP gateway converts all SIP traffic to ISUP (ISDN User Part) and also routes calls to the right PSAP (Public Safety Answering Point) 140. The Call Manager located in the SSPN (Subscription Service Provider Network) 145 handles the overall call aspects. The visiting SSPN is shown at 110 with 802.21 Information Service, Call Manger 155 and AAA 150 shown therein. Visiting SSPN 110 is in communication with Internet 115 and Home SSPN 145.

Embodiments of the present invention provide the following specific requirements for Emergency services that need to be satisfied.

Capability Advertisement: There needs to be an indication from the network about its ability to support Emergency services. There needs to be an indication for availability of location services, availability of appropriate QoS services, availability of network access in different states and availability of a high level entity to manage overall call process (broadcast of appropriate SSPN).

Network access: The user should be able to access the network and make an e911 call both when it has credentials to access the network (State 3 in 802.11 Networks) and also when it does not have credentials to access the network (State 1 in 802.11 Networks). In both cases the user should preferably use a common mechanism to initiate the e911 call. It would be preferable if this can be a common access mechanism across different 802 networks such as, but not limited to, 802.11, 802.16, etc. as well.

The network should provide a mechanism for appropriate QoS capabilities to initiate the e911 call. However, for unauthenticated users there needs to be some implementation of rate control to limit the impact of rogue users making crank e911 calls. The possibility of Denial of Service attack already exists when supporting emergency services for unauthenticated users and not much can be done about it at the 802.11 access network level. Other higher layers in the system need to recognize this and take appropriate steps.

When users have already authenticated with the network, they should preferably not be required to tear down their existing security associations when making e911 call. Also any user activity prior to making e911 call should preferably continue unhindered even during and after the completion of e911 call.

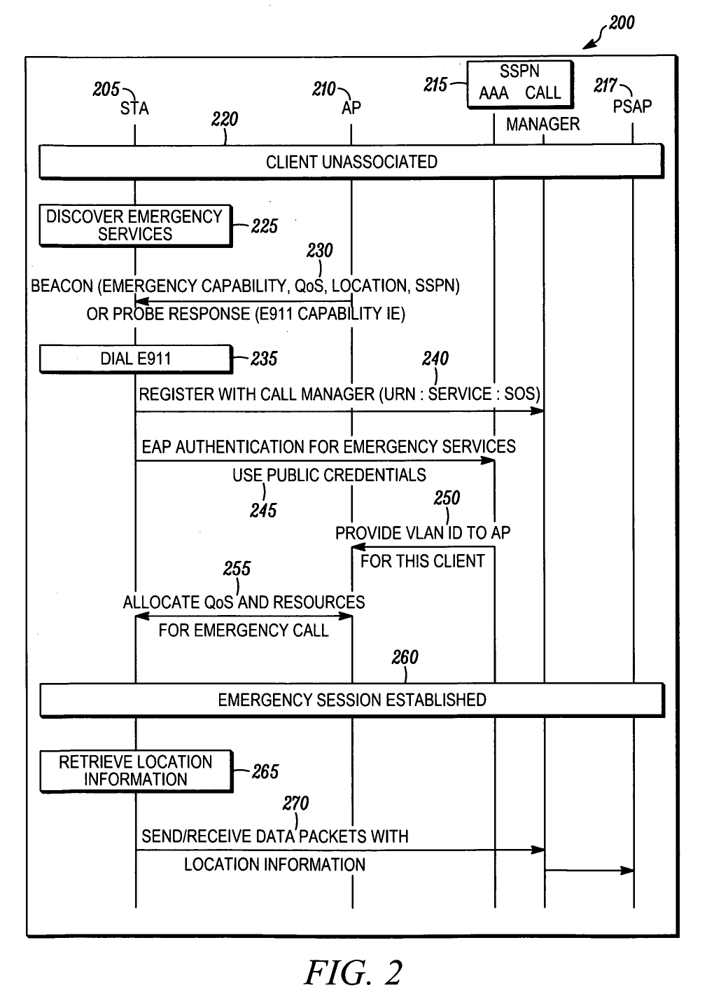

Turning on to FIG. 2 at 200 are operation and key ideas of the present invention and depict a flow diagram for placing an Emergency Call of an embodiment of the present invention.

Unassociated STA is illustrated at 205, AP 210, SSPN with AAA and Call Manager 215, and PSAP at 217. At 225 STA 205 discovers emergency services and at 230 AP 210 provides a beacon or probe response with e911 capability. At 235 STA 205 dials e911 and registers with Call Manger 215 and at 245 EAP authentication for emergency services is accomplished using public credentials. At 250 SSPN 215 provides VLAN ID to AP 210 for this client. At 255 the network allocates QoS and resources for emergency call between STA 205 and AP 210. At 260 the emergency session is established and at 265 STA 205 retrieves location information and at 270 sends/receives data packets with location information to SSPN 215 and PSAP 217.

1] If supplicant “knows” it doesn't have security credentials but needs to place an emergency call, it attempts EAP authentication with a public user account whose identity indicates the need to place an emergency call. The AP employs normal 802.11i and 802.1x functionality.

In other cases the SSPN may provide emergency services only and may be configured for open authentication.

2] SSPN's AAA server authenticates client and provides keying material to authenticator and supplicant, thereby securing the 802.11i link.

3] SSPN's AAA server provides VLAN ID back to AP (AAA servers already support this capability)—this VLAN is the “emergency” VLAN.

4] AP or DS infrastructure performs per-user policing for this VLAN ID ensuring upper-limit on resource usage commensurate with an emergency call.

5] SSPN's call manager routes call to proper PSAP.

6] The client device discovers emergency capability in infrastructure and selects SSPN that supports emergency services, supports QoS and bandwidth reservation and provides location information. It places the Emergency Call by marking it newly defined Service URN.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

We claim:

1. A method of enabling emergency services in an unauthenticated state on wireless networks, comprising:
attempting Extensible Authentication Protocol (EAP) authentication with a public user account by a client whose identity indicates the need to place an emergency call;
authenticating said client by a Subscription Service Provider Network's (SSPN's) authentication, authorization and accounting (AAA) server and providing keying material to an authenticator and supplicant, thereby securing wireless link;
providing by said SSPN's AAA server a virtual local area network identification (VLAN ID) back to an access point (AP);
performing by said AP or a distribution system (DS) infrastructure a per-user policing for said VLAN ID ensuring upper-limit on resource usage commensurate with an emergency call; and
routing said emergency call to a Public Safety Answering Point (PSAP) by said SSPN's call manager.

2. The method of claim 1, further comprising discovering by said client device emergency capability in infrastructure and selecting an SSPN that supports emergency services, supports QoS and bandwidth reservation and provides location information.

3. The method of claim 2, further comprising placing the Emergency Call by marking it a newly defined Service Uniform Resource Name (URN).

4. The method of claim 1, wherein said AP employs normal 802.11i and 802.1x functionality.

5. The method of claim 1, further comprising said (SSPN) providing emergency services only and configured for open authentication.

6. The method of claim 1, further comprising providing indications from said wireless network about it's ability to support Emergency services.

7. The method of claim 1, further comprising providing by said wireless network an indication for availability of location services, availability of appropriate QoS services, availability of network access in different states and availability of a high level entity to manage overall call process.

8. An apparatus, comprising:
a wireless client configured to enable emergency services in an unauthenticated state on wireless networks by:
attempting Extensible Authentication Protocol (EAP) authentication with a public user account by said client whose identity indicates the need to place an emergency call;
authenticating said client by a Subscription Service Provider Network's (SSPN's) authentication, authorization and accounting (AAA) server and providing keying material to an authenticator and supplicant, thereby securing wireless link;
providing by said SSPN's AAA server a virtual local area network identification (VLAN ID) back to an access point (AP);
performing by said AP or a distribution system (DS) infrastructure a per-user policing for said VLAN ID ensuring upper-limit on resource usage commensurate with an emergency call; and
routing said emergency call to a Public Safety Answering Point (PSAP) by said SSPN's call manager.

9. The apparatus of claim 8, further comprising discovering by said wireless client emergency capability in infrastructure and selecting an SSPN that supports emergency services, supports QoS and bandwidth reservation and provides location information.

10. The apparatus of claim 9, further comprising said wireless client placing the Emergency Call by marking it a newly defined Service Uniform Resource Name (URN).

11. The apparatus of claim 8, wherein said AP employs normal 802.11i and 802.1x functionality.

12. The apparatus of claim 8, further comprising said SSIS(???) providing emergency services only and configured for open authentication.

13. The apparatus of claim 8, further comprising providing indications from said wireless network about it's ability to support Emergency services.

14. The apparatus of claim 8, further comprising providing by said wireless network an indication for availability of location services, availability of appropriate QoS services, availability of network access in different states and availability of a high level entity to manage overall call process

15. An article comprising a storage medium having stored thereon instructions, that, when executed by a computing platform, results in attempting Extensible Authentication Protocol (EAP) authentication with a public user account by a client whose identity indicates the need to place an emergency call;
authenticating said client by a Subscription Service Provider Network's (SSPN's) authentication, authorization and accounting (AAA) server and providing keying material to an authenticator and supplicant, thereby securing wireless link;
providing by said SSPN's AAA server a virtual local area network identification (VLAN ID) back to an access point (AP);
performing by said AP or a distribution system (DS) infrastructure a per-user policing for said VLAN ID ensuring upper-limit on resource usage commensurate with an emergency call; and
routing said emergency call to a Public Safety Answering Point (PSAP) by said SSPN's call manager.

16. The article of claim 15, comprising further instructions that when executed further comprise discovering by said client device emergency capability in infrastructure and selecting an SSPN that supports emergency services, supports QoS and bandwidth reservation and provides location information.

17. The article of claim 16, comprising further instructions that when executed further comprise placing the Emergency Call by marking it a newly defined Service Uniform Resource Name (URN).

18. The article of claim 15, wherein said AP employs normal 802.11i and 802.1x functionality.

19. The article of claim 15, comprising further instructions that when executed further comprise said (SSPN) providing emergency services only and configured for open authentication.

20. The article of claim 15, comprising further instructions that when executed further comprise providing indications from said wireless network about it's ability to support Emergency services.
